(19) United States
(12) Patent Application Publication
(10) Pub. No.: US 2012/0072456 A1
(43) Pub. Date: Mar. 22, 2012

(54) ADAPTIVE RESOURCE ALLOCATION FOR MULTIPLE CORRELATED SUB-QUERIES IN STREAMING SYSTEMS

(75) Inventors: Parijat Dube, Hicksville, NY (US); Ankit Jain, Jersey City, NJ (US); Zhen Liu, Tarrytown, NY (US); Cathy Honghui Xia, Briarcliff Manor, NY (US)

(73) Assignee: INTERNATIONAL BUSINESS MACHINES CORPORATION, Armonk, NY (US)

(21) Appl. No.: 12/884,390

(22) Filed: Sep. 17, 2010

(51) Int. Cl. G06F 17/30; G06F 9/46

(52) U.S. Cl. 707/780; 718/104

(57) ABSTRACT

A system, method and computer program product for allocating computing resources to process a plurality of data streams. A system for allocating resources to process a plurality of data streams. The system includes, but is not limited to: a memory device and a processor being connected to the memory device. The system receives at least one query from a user. The system obtains at least one sub-query associated with the at least one query. The system identifies at least one data stream associated with the at least one sub-query. The system computes at least one probability that the at least one sub-query is true. The system assigns the computing resources to process the data streams according to the computed probability.

### BACKGROUND

The present application generally relates to allocating computing resources to process data streams. More particularly, the present application relates to query processing in data streams.

A distinguishing characteristic of today's digital world is an abundance of data. There exist applications where data is generated almost continuously, i.e. in the form of streams. Examples of such applications include, but are not limited to: real time trading, on-line auctions, intrusion detection, sensor networks monitoring and analyzing web usage and chat logs. In such applications, typically, a query is posed which is answered after analyzing relevant data stream(s). However, continuously processing and analyzing these data streams in real-time to extract information is not an easy task. Currently, there are several challenges in processing and analyzing data streams in real-time including, but not limited to:

1. It is important to process a query as quickly as possible. For example, an arbitrage opportunity in a financial trading system may disappear in few seconds. A volcano alarm system may not be useful if a warning is not early enough. However, it is often not clear how to define a relative importance of queries.

2. Processing and analyzing these data streams are a resource (CPU, Bandwidth, Disk space, Memory space, etc.) intensive task. Many times, it is not possible to extract information at a rate the data is coming to resources (e.g., computing systems, etc.). Traditionally, given limited resources, the limited resources may need to discard some data or perform an approximate processing in order to perform a computation in real time. A traditional data processing system fails to model a dependency between a data processing rate of the resources and a rate of information retrieval.

3. It is important to consider randomness involved in processing a query in data streams. Information that a data processing system (e.g., a computing system 800 in FIG. 8, etc.) is going to retrieve in future is stochastic (i.e., non-deterministic), so the data processing system may not have an exact idea of parameters, e.g., a time period that it would take to process a query. Traditionally, a model of dependency between resources and information retrieval fails to take into account those parameters.

4. Because of randomness involved, it is also important to continually update a user with a status of her/his query. For example, an answer which has a chance of being 80% correct may be valuable immediately as compared to a 99% correct answer obtained five minutes later from now.

5. Often, multiple data streams are informative in answering a query. Information from these multiple data streams may also be correlated. For example, information from a data stream may not be valuable after retrieval of same information from another correlated stream.

A traditional way that a resource allocation mechanism is formulated in traditional data processing systems is similar to a traditional job shop scheduling mechanism. For example, each processing query or job has a priority and/or a deadline and a set of computing resource requirements. Traditionally, an objective is to assign jobs to computing resources to maximize certain performance metrics e.g., minimizing an average completion time of a task, minimizing the number of jobs that violate their deadlines or minimizing computing resources required to complete a certain task. A traditional job shop scheduling mechanism in general is known to be NP(non deterministic)-hard (i.e., an efficient algorithm is unlikely to exist) and there are known heuristics to assign resources to jobs, e.g., bin packing heuristics, First Fit and Best Fit, Min-Min and Max-Min heuristics. However, a typical job shop scheduling algorithm is static, so the typical job shop scheduling algorithm fails to adapt to a dynamic nature of data streams, i.e., data streams are correlated each other and these correlation may change from time to time.

These known heuristics include, but are not limited to, following characteristics:
1. These heuristics do not consider a relationship between a data processing rate of computing resources and an information retrieval rate from a data stream.
2. A dependency among various data streams is not considered.
3. These known heuristics fail to adjust a resource allocation dynamically, and fail to consider a future impact of a current resource allocation.

Traditional active learning techniques (i.e., a traditional model that focuses on a responsibility of learning on learners) decides which sensors/variables for a data computing system to observe to obtain maximum information about a topic, subject or query. Each sensor/variable reading incurs a cost but provides some information about the topic, subject or query. Although the traditional active learning considers the dependencies or correlations between various sensor/variable readings, this traditional active learning technique is not suitable for processing data streams due to at least following reasons:
1. It is important to split computing resources in data processing systems to process different data streams to retrieve maximum information as the data streams is generated continually. However, the traditional active learning is designed for environments where there are a fixed number of data points known beforehand. In other words, these data points have fixed values and do not change their values over times.
2. The active learning selects and fixes sensor nodes (i.e., computers for processing data) before anything is inputted to the nodes. Thus, the active learning is unsuitable for processing data streams whose importance and relevancy are dynamically changing over time. Furthermore, computational costs of the active learning are undesirable for processing data streams with low latency (e.g., less than 1 second latency).

### SUMMARY OF THE INVENTION

There is provided a system, method and computer program product for allocating IT (Information Technology) computing resources to process a plurality of data streams.

In one embodiment, there is provided a system for allocating computing resources to process a plurality of data streams. The system includes, but is not limited to: a memory device and a processor being connected to the memory device. The system receives at least one query from a user. The system obtains at least one sub-query associated with the at least one query. The system identifies at least one data stream associated with the at least one sub-query. The system computes at least one probability that the at least one sub-query is true. The system assigns the computing resources to process the data streams according to the computed probability.

In a further embodiment, the system receives rules and dependencies between the at least one sub-query from a user.

In a further embodiment, the system updates the probability of each sub-query based on the processed data streams.

In a further embodiment, the system propagates the updated probability to other sub-queries. The system evaluates whether the updated probability satisfies a predetermined criterion.

### BRIEF DESCRIPTION OF THE DRAWINGS

The accompanying drawings are included to provide a further understanding of the present invention, and are incorporated in and constitute a part of this specification.

FIG. 1 illustrates a flow chart that describes method steps for allocating computing resources to process a plurality of data streams in one embodiment.

FIG. 2 illustrates a hierarchical structure of exemplary sub-queries in one embodiment.

FIG. 3 illustrates exemplary data streams relevant to sub-queries in one embodiment.

FIG. 4 illustrates an exemplary model building in one embodiment.

FIG. 5 illustrates splitting computing resources among sub-queries in one exemplary embodiment.

FIG. 6 illustrates exemplary sub-queries whose probabilities meet a predetermined criterion in one embodiment.

FIG. 7 illustrates exemplary updating of sub-queries and their probabilities in one embodiment.

FIG. 8 illustrates an exemplary hardware configuration for allocating computing resources to process a plurality of data streams in one embodiment.

### DETAILED DESCRIPTION

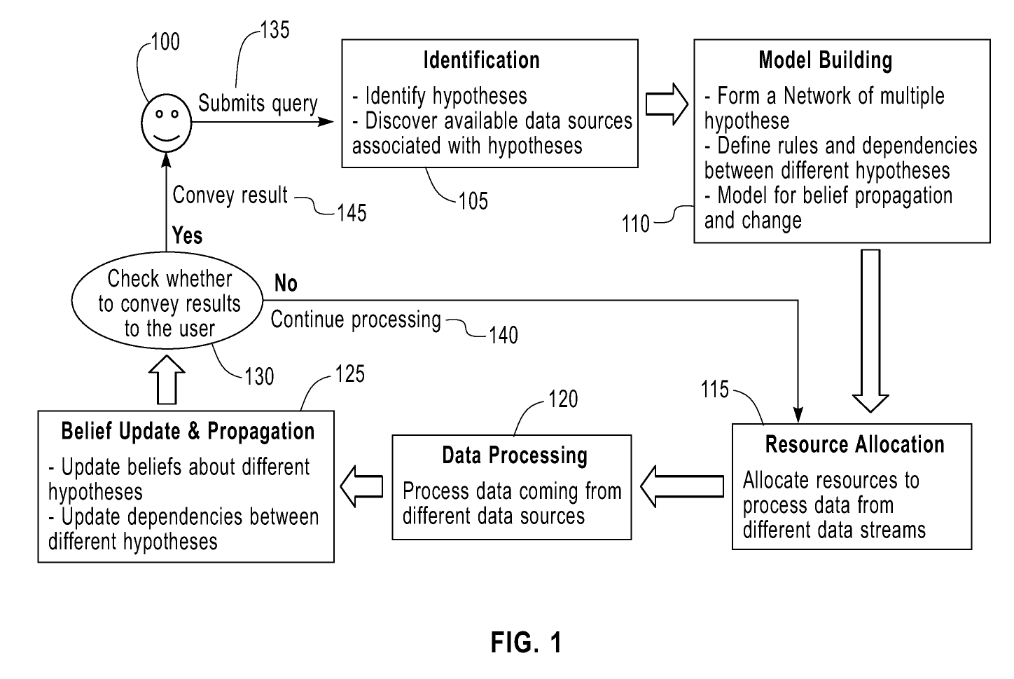

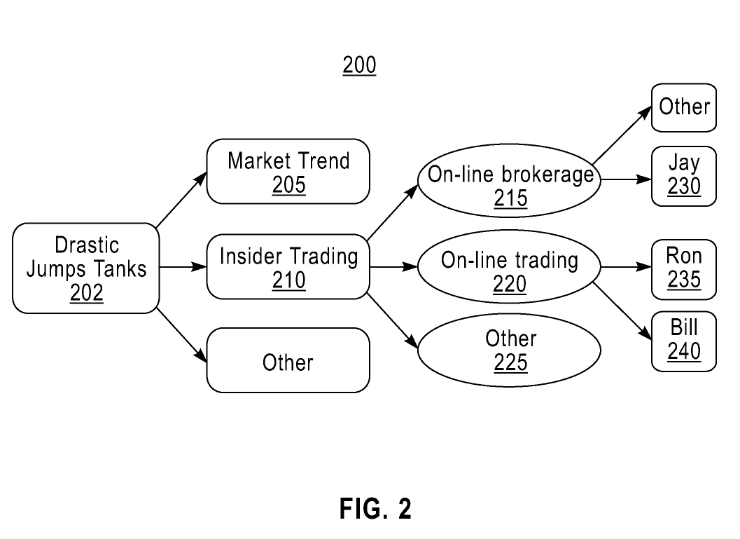

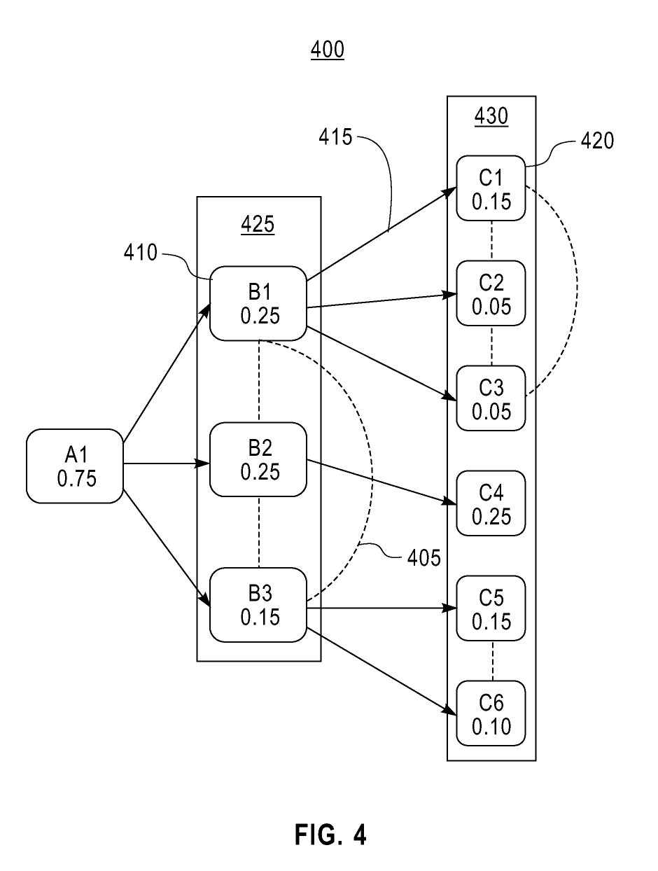

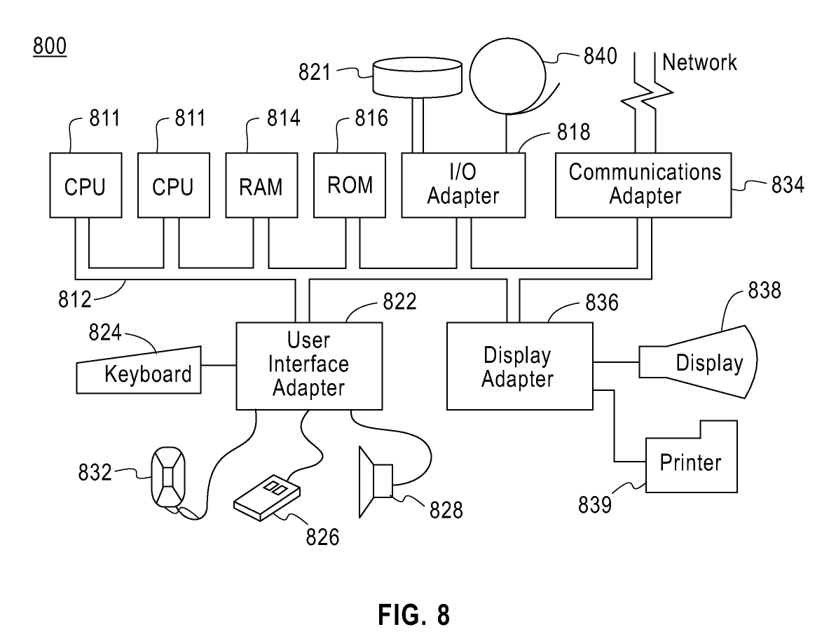

FIG. 1 is a flow chart that describes method steps for allocating computing resources (e.g., a server, workstation, processor, software, memory space, network bandwidth, laptop, desktop, tablet computer, or other equivalent computing device/entity etc.) to process a plurality of data streams in one embodiment. A resource allocation scheme described in FIG. 1 for processing a query in data streams (e.g., real-time stock market data, etc.) takes into account one or more of: (a) a dependency (i.e., interrelationship) between various sources (e.g., Bloomberg®, New York Stock Exchange, etc.) of data; (b) a probabilistic relationship (e.g., a model 400 in FIG. 4) between an information retrieval rate of computing resources and a data processing rate of computing resources; (c) a dynamic way to split available computing resources among data streams to maximize information gain. A data processing system (e.g., a computing system 800 in FIG. 8, IBM® InfoSphere™ Streams, etc.) runs the resource allocation scheme described in FIG. 1 in a data streaming environment where various sub-queries related to a query are defined, e.g., by users, and data streams are grouped with sub-queries. These sub-queries are related probabilistically and hence form a hierarchical structure (e.g., Bayesian network, an exemplary hierarchical structure 200 illustrated in FIG. 2). The data processing system uses a resource allocation mechanism based on belief update equations and/or user's utility function to split computing resources among sub-queries and subsequently among data streams. That resource allocation mechanism allocates computing resources to the sub-queries according their likelihood to be true. In one embodiment, a user's utility function is a measure of a relative satisfaction that the user may define as a function of different possible state of outcomes. For example, a user may be satisfied (or has utility) if the user's query is answered with a high degree of confidence (e.g., 99% accuracy). The user's utility function assigns utilities (or a monetary value) to sub-queries according to various degrees of confidence. The user's utility function, for example, may assign a utility of zero if a sub-query is answered correctly with less than 90% confidence and a utility of one if a sub-query is answered correctly with more than 90% confidence.

In FIG. 1, a user 100 submits a query 135 to a data processing system (e.g., a computing system 800 in FIG. 8, etc.). At step 105, the data processing system receives the query and the system creates sub-queries associated with the query, e.g., by running a query generation algorithm (Note that a sub-query is also a query). Vladimir A. Kulyukin, “Automated Query Generation For Embedded Information Retrieval,” IJCAI's Workshop on Intelligent Techniques for Web Personalisation, August 2001, wholly incorporated by reference, describes an algorithm to automatically generate a query. In one embodiment, each sub-query is a YES/NO question associated with the query. In one embodiment, the user 100 manually creates the sub-queries and assigns a probability to be true to each sub-query, e.g., based on his/her prior knowledge and/or experiences. These sub-queries range from coarser to finer. A coarse sub-query, if found to be true, is unlikely to give exact answer to the query but likely give some useful information. A fine sub-query, if true, may give an exact answer, but a chance of being true is low (e.g., less than 20%).

For example, suppose that a Financial Industry Regulatory Authority (FINRA) is interested in finding if there is an insider trading in a stock market and, if so, who is the insider trader. A user in FINRA may submit a query to the data processing system: “Is there an insider trading? If so, who is the inside trader?” In one embodiment, the user submits a query to the data processing system, e.g., through a user interface to specify queries, or by using SQL. The user may also create sub-queries (i.e., Yes/No questions that narrow the query submitted from the user) associated with the query including, but not limited to:

(FIG. 2 illustrates these sub-queries that form a hierarchical structure 200, which includes, but is not limited to: a Bayesian network. David Heckerman, “A Tutorial on Learning With Bayesian Networks,” March 1995, Microsoft Corporation, wholly incorporated by reference as if set forth herein, describes Bayesian network in detail.)
1. A first sub-query 205 in FIG. 2: “Does the stock price move normally?”
2. A second sub-query: “Can an abnormal behavior be attributed to market effect?”
3. A third sub-query 210 in FIG. 2: “Is the abnormal behavior due to an insider trading?”
4. A fourth sub-query 215 in FIG. 2: “Is insider trading happening through an online brokerage firm?”
5. A fifth sub-query 220 in FIG. 2: “Is insider trading happening through an online trading?”
6. A sixth sub-query 225 in FIG. 2: “Is insider trading happening through some other method?”
7. A seventh sub-query 230 in FIG. 2: “Is Jay an insider trader?”
8. An eighth sub-query 235 in FIG. 2: “Is Ron an insider trader?”
9. A ninth sub-query 240 in FIG. 2: “Is Bill an insider trader?”
10. A tenth sub-query 202 in FIG. 2: “Does a stock market price jump or tank?”
In one embodiment, the user submits the sub-queries to the data processing system, e.g., through a user interface to specify sub-queries, or by using SQL. A set of sub-queries (e.g., the sub-queries described in the above example) need not be complete. Sub-queries can be added or removed whenever the user wants.

After creating the sub-queries, the user manually identifies data streams associated with each sub-query, e.g., based on his/her knowledge and/or preliminary analysis on the data streams. In another embodiment, the data processing system identifies relevant data streams, e.g., by performing data stream mining (i.e., process of extracting information from continuous rapid data streams) on all the data streams based on each sub-query. Wei Fan, et al., “Active Mining of Data Streams,” Society for Industrial And Applied Mathematics—Data mining proceeding, 2004, wholly incorporated by reference, describes a data stream mining technique. In another embodiment, the data processing system identifies relevant data streams, e.g., by using a fluid/diffusion model (i.e., a mathematical equation that estimates a spread of information through users or sub-queries) which describes a change in a probability of a sub-query as a function of a current probability of the sub-query, computing resource(s) applied on the sub-query and/or Brownian motion (e.g., random movement in the change of the probability in a continuous time). In one embodiment, the data processing system forms a probabilistic model (e.g., a model 400 in FIG. 4 described below) that describes how a probability of a sub-query as a resource is applied to a data stream associated with the sub-query, e.g., by running an algorithm for building a tree data structure representing the sub-queries and then assigning a probability to each node representing a sub-query. The data processing system corresponds each sub-query to at least one data stream relevant to it.

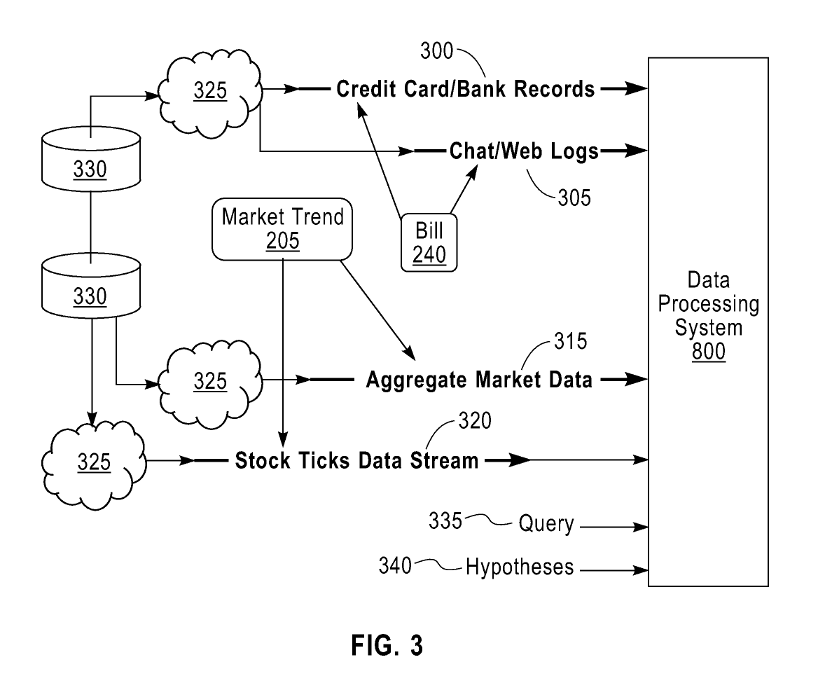

FIG. 3 illustrates exemplary data streams associated with sub-queries in one embodiment. For example, the user 100 in FIG. 1, based on his/her knowledge and/or experiences, determines that data streams of stocks 320 and other related financial securities price quotes and transaction volumes 315 are relevant to the first sub-query 205, whether the stock price movement is normal or not. The user 100, based on his/her knowledge and/or experiences, determines that a data stream of logs 300 of transactions histories of brokerage firms are relevant to whether a particular broker is involved or not. Similarly, the user 100, based on his/her knowledge and/or experiences, determines that a data stream of chat/VoIP/web usage logs 305 of the particular broker is relevant to the ninth sub-query 240, whether that particular broker is the insider trader. In one embodiment, a server device (not shown) having at least one database or storage device (e.g., storage device 330) provides these data streams via a network (e.g., Internet 325) to users and/or the data processing system 800. The data processing system 800 receives at least one query 335 and at least one sub-query 340 associated with the query 335 from the user.

Returning to FIG. 1, at step 110, the data processing system receives rules and/or dependencies between sub-queries as inputs from the user. Examples of the rules include, but are not limited to: (1) A sub-query “h1” is true only if a sub-query “h2” is true; (2) If a sub-query “h3” is true, then a sub-query “h4” cannot be true. An example of dependency between sub-queries includes, but is not limited to: if a sub-query “h1” is true, then a sub-query “h2” is less likely to be true (e.g., less than 40% chance to be true). This less likelihood may be reflected on a probability distribution that specifies a joint probability of the sub-queries “h1” and “h2.” In one embodiment, the user chooses this joint probability distribution of the sub-queries “h1” and “h2” to configure dependency between the sub-queries “h1” and “h2.”

In one embodiment, the sub-queries form a hierarchical structure (e.g., a hierarchical structure 200 in FIG. 2). A rule may specify that if a set of sub-queries are true, another set of sub-queries can be true. For example, if “Jay” 230 in FIG. 2 is determined as an insider trader, since “Jay” 230 used an on-line brokerage firm 215 to perform insider trading, the on-line brokerage firm 215 may also be involved in the insider trading. In one embodiment, the sub-queries form a probabilistic model. In this probabilistic model, sub-queries in a layer may have probabilistic dependencies among them, e.g., given a sub-query is true, there is very slight chance (e.g., less than 20%) of another sub-query in the same layer to be true. FIG. 4 illustrates an exemplary probabilistic model of sub-queries. In FIG. 4, it is given that each chance of sub-queries B1 and B2 to be true is 25% and a chance of a sub-query B3 to be true is 15%. A sum of chances of sub-queries at a lower layer to be true is equal to chance(s) of sub-queries at a direct upper layer to be true. For example, in FIG. 4, a sum of chances of sub-queries C1, C2 and C3 is equal to a chance of a sub-query B1. In one embodiment, these hierarchical and/or probabilistic model form a Bayesian network of sub-queries where each node (e.g., a node 405) represents a sub-query and an edge (e.g., an edge 410) between the nodes represents a dependence between the corresponding sub-queries.

Suppose that pₜ is a probability that a certain sub-query is true at time instant t. Under certain assumptions, a change in pₜ, dpₜ as resources, can be shown to satisfy:

dpₜ=βpₜ(1−pₜ)f(Rₜ)dWₜ (1)

where β is a constant, f is a concave function (i.e., a negative of a convex function), Rₜ is an amount of computing resources applied to the data streams relevant to the sub-query and Wₜ is a Brownian motion. dWₜ represents a change in Wₜ. The data processing system runs formula (1) to calculate an expected instantaneous utility (e.g., a degree of relevancy to the query) of a sub-query as a function of computing resources allocated to various data streams. The data processing system eventually uses the formula (1) to calculate a resource allocation scheme. For example, the resource allocation scheme allocates computing resources to sub-queries and their corresponding data streams to maximize the instantaneous utility (i.e., the output value of the formula (1)).

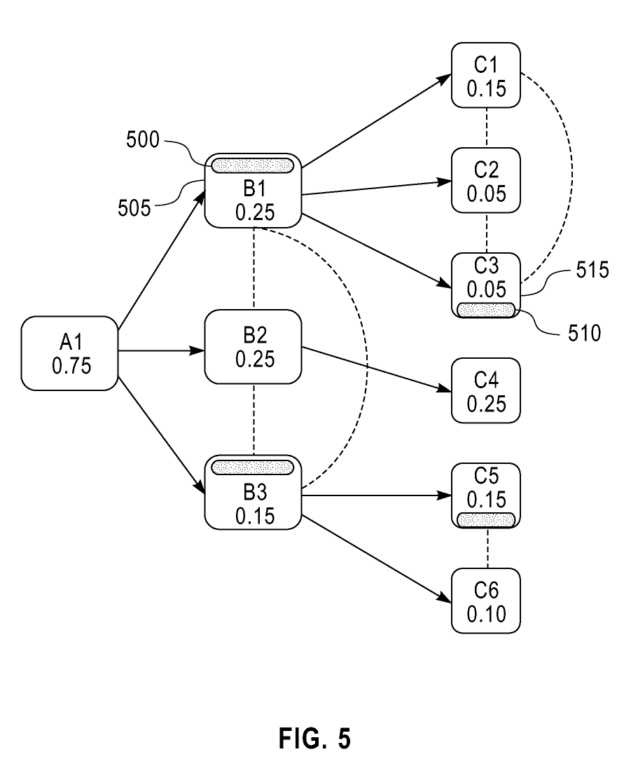

The fluid/diffusion model (e.g., formula (1)) associates a data processing rate of the computing resources (“Rₜ”) with a rate of information retrieval (“pₜ”). There may be certain rules and/or dependencies which relate various sub-queries. For example, some sub-queries have to be true if another sub-query is true. In a hierarchical structure of sub-queries, a sub-query in a parent layer (e.g., a layer 425 in FIG. 4) has to be true if any of sub-queries in a subsequent layer (e.g., a layer 430 in FIG. 4) is true. This hierarchical structure makes propagating probabilities easier as described below. Sub-queries in a layer may have at least one negative correlation (e.g., a negative correlation 405 in FIG. 5) among them. Referring to the insider trading example illustrated in FIG. 2, if the on-line brokerage firm is the only brokerage account of “Jay” and if the sub-query 230 that “Jay” is an insider trader is true, then the sub-query 215 that the insider trading happens through the on-line brokerage firm has to be true. Then, the truth of the sub-query 215 may reduces the probabilities to be true of other sub-queries 225 if “Jay” used only the on-line brokerage firm to perform the insider trading.

Returning to FIG. 1, at step 115, the data processing system computes a resource allocation among sub-queries, e.g., by using the resource allocation mechanism described above. FIG. 5 illustrates an exemplary resource allocation to sub-queries. In FIG. 5, the data processing system allocates a resource group 500 (i.e., a set of multiple resources) to a sub-query B1 505 according to a myopic resource allocation algorithm. The myopic resource algorithm allocates a particular amount of computing resources to a sub-query based on a probability of the sub-query to be true. In FIG. 5, the data processing system allocates 25% of total computing resources to the sub-query B1 505. Then, the data processing system allocates a portion 510 (e.g., ⅕) of the resource group 500 to a sub-query C3 515. Again, according to the resource allocation mechanism, the data processing system allocates 5% of the total computing resources to the sub-query C3 515.

In one embodiment, after deriving the belief propagation equations based on the probabilities of sub-queries and/or user's utility function (i.e., an information theoretic objective, for example, an integral of time discounted sum of probabilities of leaf nodes or integral of time discounted sum of variances of leaf nodes), the data processing system allocates computing resources to an individual sub-query. The myopic algorithm allocates computing resources to maximize an instantaneous objective (e.g., a total entropy of the data processing system at a time t). The data processing systems distributes or assigns the computing resources to process the data streams according to the computed resource allocation. For example, in FIG. 3, if a computing resource 1 (e.g., a computing node) (not shown) is assigned to the sub-query 240, since the sub-query 240 is associated with data streams 300-305, the computing resource 1 is eventually assigned to process the data streams 300-305. While computing resources process the data streams, the data processing system monitors the processed data streams pertinent to the sub-queries of the query. In one embodiment, the information being monitored/obtained depends on a nature of a query and/or a type of a data stream being processed. For example, if the query is about an insider trading and the processed data stream is on stock ticker data from NYSE (New York Stock Exchange), then the data processing system monitors the time series of stock ticker data, and applies (i) a Filtering Operator (not shown) to filter out normal stock ticker data and (ii) a Change detection operator (not shown) to identify any anomalies in the stock ticker data.

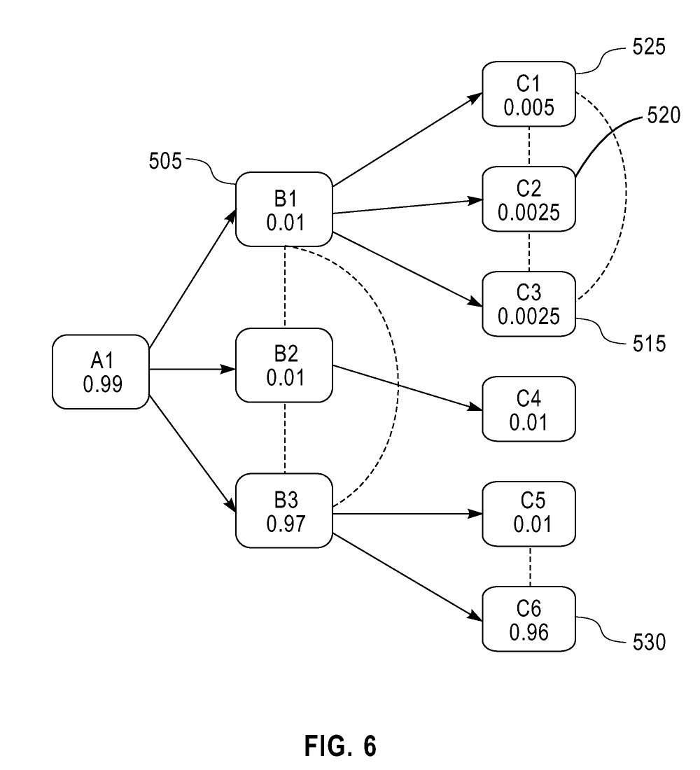

Referring back to FIG. 1, at step 120, the computing resources process the data streams, e.g., to obtain an answer to the query. At step 125, the data processing system updates a probability to be true of each sub-query based on the processed data stream, e.g., according to Bayes' rule. In one embodiment, when a belief (i.e., probability) of one sub-query is updated, the beliefs (i.e., probabilities) of other sub-queries are also changed. In other words, a change in a belief in one sub-query is propagated to cause changes of other sub-queries. These propagated changes occur because these sub-queries are related by various rules and dependencies. Mathematically, these relations can be expressed as belief propagation equations or user's utility functions. In one embodiment, the data processing system allocates or assigns or distributes computing resources to the data streams corresponding to the sub-query. After processing the data streams, the data processing system collects information associated with the query. Based on these collected information, the data processing system calculates new probabilities of sub-queries according to Bayes' rule. Bayes' rule describes a relationship between a probability and its inverse. Geoff Bohling, “Applications of Bayes' Theorem,” September 2005, wholly incorporated by reference, describes Bayes's rule in detail. According to Bayes' rule, observed evidence or collected data affects a probability of a sub-query associated with the evidence or data. The affected probability of the sub-query also affects the evidence or data. For example, while processing the data streams, each probability to be true of each sub-query may change as shown in FIGS. 5-6. Before processing the data streams, a probability to be true of the sub-query B1 505 is 0.25 as shown in FIG. 5. However, after processing some of the data streams, the probability of the sub-query B1 505 becomes 0.01 as shown in FIG. 6. This change of the probability continuously occurs as the data processing system obtains more information from the processed data streams. For example, in the insider trading example shown in FIG. 3, while processing data streams 300-305, the data processing system and/or user finds that the sub-query 240 is less likely to be true. Then, the data processing system reduces the probability of the sub-query 240. As described above, probabilities are continuously updated according to Bayes' rule. If the collected information (based on processing of data streams) is contrary to a sub-query, then the probability of the sub-query being true is reduced according to Bayes' rule. The data processing system adaptively changes resource allocations to the sub-queries and to the data streams according to the change of the probability.

In one embodiment, the data processing system propagates the updated probability of a sub-query to other sub-queries, e.g., by using Junction tree algorithm, sum-product algorithm and/or Gibbs Sampling algorithm. David Kahle, “Junction Tree Algorithm,” Rice University, September, 2008, wholly incorporated by reference as if set forth herein, describes Junction tree algorithm in detail. Michael E. O'Sullivan, et al. “The sum-product algorithm on simple graphs,” 2009, San Diego State University, wholly incorporated by reference as if set forth herein, describes sum-product algorithm in detail. Eric C. Rouchka, “A Brief Overview of Gibbs Sampling,” IBC Statistics Study Group, May, 1997, wholly incorporated by reference as if set forth herein, describes Gibbs sampling algorithm in detail. For example, in FIG. 6, after probabilities of sub-queries C1-C3 (515-525) are updated, a probability of a sub-query B1 (505) is also changed from 0.25 to 0.01: 0.0025+0.0025+0.005=0.01. Thus, the data processing system propagates changes in probabilities of sub-queries from leaf nodes to root node, e.g., in a hierarchical structure (e.g., a model 400 in FIG. 4). In one embodiment, the data processing system monitors a probability of each sub-query and updates the probability of that sub-query whenever a probability of a sub-query at a lower layer (e.g., a layer 430 in FIG. 4) has been updated. In a further embodiment, the data processing system also updates a belief propagation equation when updating a probability of a sub-query associated with the belief propagation equation.

The data processing system continuously and dynamically updates probabilities of sub-queries based on the processed data streams as described above. The data processing adaptively changes the resource allocation to the sub-queries and corresponding data streams according to the updated probabilities. Returning to FIG. 1, at step 130, the data processing system evaluates whether the updated probabilities meet a predetermined criterion (e.g., a sum of probabilities of leaf nodes in a hierarchy are lower than a predetermined threshold). If the updated probabilities meet the criterion, at step 145, the data processing system conveys the updated probabilities to the user 100, e.g., by an email, text message, instant message, etc. Otherwise, at step 140, the control returns to the method step 115 to repeat the method steps 115-130. If the user continuously submits new queries, the data processing system continuously conveys results (the updated probabilities) to the user 100. The user 100 is able to find out an answer to his/her query based on the updated probabilities of the sub-queries. (A sub-query that has the highest probability to be true is likely the answer to the query.) In the insider trading example, if a probability of the ninth sub-query 204 becomes 0.99 at the step 130 (after updating and propagation), the user 100 knows that “Bill” is highly likely (e.g., 99%) to be the inside trader and that “Bill” used the on-line trading method 220 to perform the inside trading.

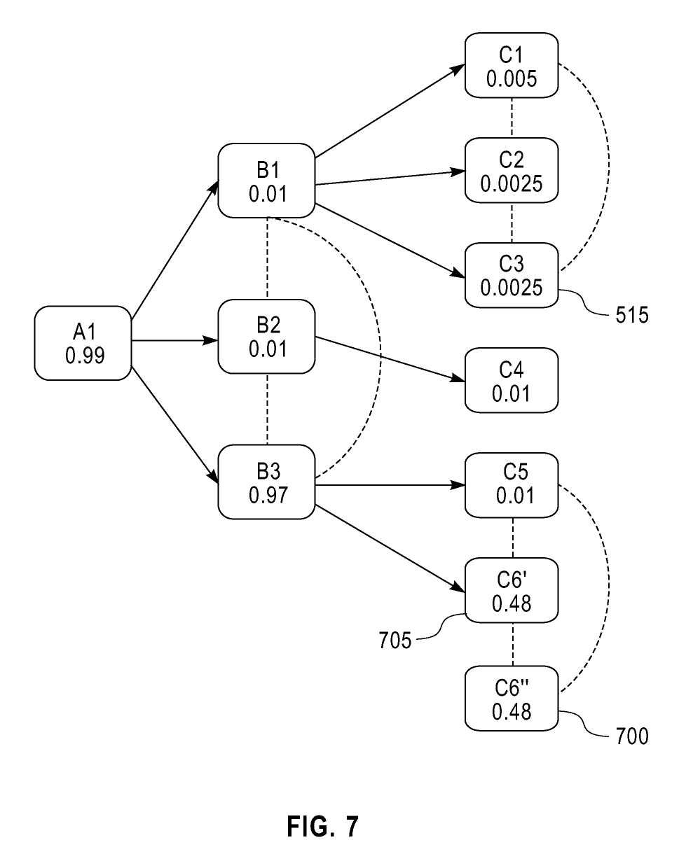

At step 130, the user 100 optionally adds new sub-queries and removes existing sub-queries based on the updated probabilities. FIGS. 6-7 illustrates that the user 100 removes a sub-query and adds new sub-queries based on the updated probabilities. FIG. 6 shows that a probability to be true of a sub-query C6 530 is 0.96. Thus, based on this high probability (e.g., larger than 0.9) to be true, as shown in FIG. 7, the user 100 removes the sub-query C6 530 and adds two new sub-queries C6′ (705) and C6″ (700) whose probabilities to be true are 0.48 respectively. In one embodiment, a set of sub-queries need not be specified fully at the start of the method step 100 in FIG. 1. Thus, a hierarchical structure (e.g., a tree data structure 400 in FIG. 4) of the sub-queries may not be fully specified at the start of the method step 100 in FIG. 1. If the sub-query C6 530 in FIG. 6 is true and if either of sub-queries C6′ (705) or C6″ (700) in FIG. 7 is true, then in one embodiment the user may want to explore the sub-query C6 530, e.g., by adding sub-queries C6′ (705) or C6″ (700) to the system. Then, the user may be able to figure out what exactly is the reason for C6 530 to highly likely be true (e.g., 96% chance to be true). According to the insider trading example, if the sub-query C6 530 is an inside trader who uses a brokerage account “A”, then the sub-queries C6′ (705) and C6″ (700) can be sub-queries that John or Bill is the inside trader respectively, where John and Bill are the only traders who use the brokerage firm “A”. Similarly, the user may decide to remove a sub-query if the probability of it being true is currently being deemed too low (e.g., less than 10% chance to be true). This addition and removal of sub-queries prevent the number of sub-queries from exploding.

In one embodiment, the data processing system performs the method steps 100-130 and 140-145 in real-time. Alternatively, the data processing system performs some of the method steps off-line. In one embodiment, the data processing system allocates computing resources in conjunction with evaluating sub-queries. Thus, there may exist a feedback loop comprising: belief propagation about different sub-queries, e.g., updating belief equations about different sub-queries→identification of candidate data streams to process→resource allocation to the sub-queries for processing data streams associated with the sub-queries→monitoring and processing of the data streams→belief equation updates about different sub-queries.

FIG. 8 illustrates an exemplary hardware configuration of the computing system 800 that implements the data processing system. The hardware configuration preferably has at least one processor or central processing unit (CPU) 811. The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting the system 800 to a data processing network, the Internet, an Intranet, a local area network (LAN), etc., and a display adapter 836 for connecting the bus 812 to a display device 838 and/or printer 839 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for allocating computing resources to process a plurality of data streams, the method comprising:
receiving at least one query from a user;
obtaining at least one sub-query associated with the at least one query;
identifying at least one data stream associated with the at least one sub-query;
computing at least one probability that the at least one sub-query is true; and
assigning the computing resources to process the data streams according to the computed probability,
wherein a computing system including at least one processor performs one or more of: the receiving, the creating, the identifying, the computing and the assigning.

2. The method according to claim 1, further comprising:
receiving rules and dependencies between the at least one sub-query from a user.

3. The method according to claim 1, further comprising:
updating the at least one probability of the at least one sub-query.

4. The method according to claim 3, further comprising:
propagating the updated probability to other sub-queries; and
evaluating whether the updated probability satisfies a predetermined criterion.

5. The method according to claim 4, further comprising:
repeating the identifying, the computing, the assigning, the updating, the propagating, and the evaluating.

6. The method according to claim 4, wherein the propagating includes using one or more of: Bayes' rule, Junction tree algorithm, sum-product algorithm, and Gibbs Sampling algorithm.

7. The method according to claim 1, wherein a user identifies the at least one data stream associated with the at least one sub-query.

8. The method according to claim 1, wherein the sub-queries forms a hierarchical structure.

9. The method according to claim 8, wherein the hierarchical structure is a Bayesian network.

10. A system for allocating computing resources to process a plurality of data streams, the system comprising:
a memory device; and
a processor being connected to the memory device,
wherein the processor is configured to:
receive at least one query from a user;
obtain at least one sub-query associated with the at least one query;
identify at least one data stream associated with the at least one sub-query;
compute at least one probability that the at least one sub-query is true; and
assign the computing resources to process the data streams according to the computed probability.

11. The system according to claim 10, wherein the processor is further configured to:
receive rules and dependencies between the at least one sub-query from a user.

12. The system according to claim 11, wherein the processor is further configured to:
update the probability of each sub-query based on the processed data streams.

13. The system according to claim 12, wherein the processor is further configured to:
propagate the updated probability to other sub-queries; and
evaluate whether the updated probability satisfies a predetermined criterion.

14. The system according to claim 13, wherein the propagating includes using one or more of: Bayes' rule, Junction tree algorithm, sum-product algorithm, and Gibbs Sampling algorithm.

15. The system according to claim 10, wherein a user identifies the at least one data stream associated with the at least one sub-query.

16. The system according to claim 10, wherein the sub-queries forms a hierarchical structure.

17. The system according to claim 16, wherein the hierarchical structure is a Bayesian network.

18. A computer program product for allocating computing resources to process a plurality of data streams, the computer program product comprising a storage medium readable by a processing circuit and storing instructions run by the processing circuit for performing a method, the method comprising:
receiving at least one query from a user;
obtaining at least one sub-query associated with the at least one query;
identifying at least one data stream associated with the at least one sub-query;
computing at least one probability that the at least one sub-query is true; and
assigning the computing resources to process the data streams according to the computed probability.

19. The computer program product according to claim 18, wherein the method further comprises:
updating the at least one probability of the at least one sub-query.

20. The computer program product according to claim 19, wherein the method further comprises:
propagating the updated probability to other sub-queries; and
evaluating whether the updated probability satisfies a predetermined criterion; and
repeating the identifying, the computing, the assigning, the updating, the propagating, and the evaluating.
